(19) United States
(12) Patent Application Publication
(10) Pub. No.: US 2024/0219938 A1
(43) Pub. Date: Jul. 4, 2024

(54) HUMIDITY CONTROL METHOD, APPARATUS, DEVICE AND STORAGE MEDIUM

(71) Applicant: SHENZHEN CHENBEI TECHNOLOGY CO., LTD., Shenzhen (CN)

(72) Inventors: Yixu ZHANG, Shenzhen (CN); Jianzeng LI, Shenzhen (CN)

(21) Appl. No.: 18/399,273

(22) Filed: Dec. 28, 2023

(30) Foreign Application Priority Data
Dec. 30, 2022 (CN) 202211739689.0

(51) Int. Cl. G05D 22/02

(52) U.S. Cl. CPC G05D 22/02

(57) ABSTRACT

A humidity control method includes: obtaining target plant information associated with a target humidifier, and determining plant suitable humidity information based on the target plant information; based on the plant suitable humidity information, determining a target humidity value; and based on the target humidity value, controlling operation of the target humidifier.

### CROSS-REFERENCE TO RELATED APPLICATION

This application claims priority to Chinese Patent Application No. 202211739689.0, filed on Dec. 30, 2022, and the entire content of which is incorporated herein by reference.

### TECHNICAL FIELD

The present disclosure relates to the technical field of smart home technology, and more particularly, to a humidity control method, apparatus, device, and storage medium.

### BACKGROUND

In the existing technology, indoor humidity may become dry under certain circumstances due to weather or change of seasons, and may affect people or plants indoors. The indoor humidity is also affected by the number and type of indoor plants.

A humidifier is often set up for humidity control. A user can manually adjust and control the humidifier to operate under a target humidity.

In this case, the user may not be able to quickly and accurately know what humidity value is reasonable. When the desired humidity changes due to the number and/or variety of plants in the room, the target humidity of the humidifier needs to be manually adjusted repeatedly. It is inconvenient for the user to operate the humidifier to effectively adjust and control the humidity.

### SUMMARY

One aspect of the present disclosure provides a humidity control method. The method includes: obtaining target plant information associated with a target humidifier, and determining plant suitable humidity information based on the target plant information; based on the plant suitable humidity information, determining a target humidity value; and based on the target humidity value, controlling operation of the target humidifier.

Another aspect of the present disclosure provides a humidity control device. The device includes a memory storing a computer program and a processor. When being executed by the processor, the computer program causes the processor to: obtain target plant information associated with a target humidifier, and determine plant suitable humidity information based on the target plant information; based on the plant suitable humidity information, determine a target humidity value; and based on the target humidity value, control operation of the target humidifier.

Another aspect of the present disclosure provides a computer-readable storage medium storing a computer program. When being executed by a processor, the computer program causes the processor to: obtain target plant information associated with a target humidifier, and determine plant suitable humidity information based on the target plant information; based on the plant suitable humidity information, determine a target humidity value; and based on the target humidity value, control operation of the target humidifier.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts and may be encompassed in the present disclosure.

FIG. 1 is a flowchart of an exemplary humidity control method according to some embodiments of the present disclosure;

FIG. 2 is a flowchart of determining plant change information according to some embodiments of the present disclosure;

FIG. 3 is a schematic structural diagram of an exemplary humidity control device according to some embodiments of the present disclosure; and

FIG. 4 is a schematic structural diagram of an exemplary computer device according to some embodiments of the present disclosure.

### DETAILED DESCRIPTION OF THE EMBODIMENTS

In the following description, for the purpose of illustration rather than limitation, specific details such as system structures and technologies are provided to provide a thorough understanding of the embodiments of the present disclosure. However, it will be apparent to those skilled in the art that the present disclosure may be practiced in other embodiments without these specific details. In other instances, detailed descriptions of well-known systems, devices, circuits, and methods are omitted so as not to obscure the description of the present disclosure with unnecessary details.

It will be understood that, when used in the specification and the appended claims, the term “comprising” indicates the presence of described features, integers, steps, operations, elements and/or components but does not exclude one or more other features, the presence or addition of a whole, a step, an operation, an element, a component, and/or a collection thereof.

It should also be understood that the terminology used in the specification of the present disclosure is for the purpose of describing particular embodiments only and is not intended to be limiting of the present disclosure. As used in the specification and the appended claims, the singular forms “a”, “an” and “the” are intended to include the plural forms unless the context clearly dictates otherwise.

It will be further understood that the term “and/or” as used in the specification and the appended claims refers to and includes any and all possible combinations of one or more of associated listed items.

As used in the specification and the appended claims, the term “if” may be interpreted as “when” or “once” or “in response to determining” or “in response to detecting” depending on the context. Similarly, the phrase “if determined” or “if [the described condition or event] is detected” may be interpreted, depending on the context, to mean “once determined” or “in response to a determination” or “once the [described condition or event] is detected” or “in response to detection of [the described condition or event]”.

In some implementations, a computer device described in the embodiments of the present application includes, but is not limited to, a portable device such as a mobile phone, a laptop computer, or a tablet computer with touch-sensitive surfaces (e.g., touch screen displays and/or touch pads). It should also be understood that in certain embodiments, the computer device is not a portable communication device, but rather a desktop computer having a touch-sensitive surface (e.g., a touch screen display and/or touch pad).

In the following description, the computer device including displays and touch-sensitive surfaces is described. However, it should be understood that the computer device may include one or more other physical user interface devices such as a physical keyboard, mouse, and/or joystick.

The computer device supports a variety of applications, such as one or more of the following: drawing applications, presentation applications, word processing applications, website creation applications, disk burning applications, spreadsheet applications, gaming applications, telephony applications, video conferencing applications, email applications, instant messaging applications, exercise support applications, photo management applications, digital camera application, digital video camera applications, web browsing applications, digital music player applications and/or digital video player applications.

Various applications executed by the computer device may use at least one common physical user interface device, such as a touch-sensitive surface. One or more functions of the touch-sensitive surface and corresponding information displayed on the computer device may be adjusted and/or changed between applications and/or within the respective application. In this way, the common physical architecture of the computing device (e.g., touch-sensitive surface) can support a variety of applications with user interfaces that are intuitive and transparent to a user.

It should be understood that the sequence number of each step in the embodiments does not indicate an execution order. The execution order of each process should be determined by its function and internal logic, and should not constitute any limitation on the implementation process of the embodiments of the present disclosure.

To illustrate the technical solutions described in the specification, specific examples are provided below.

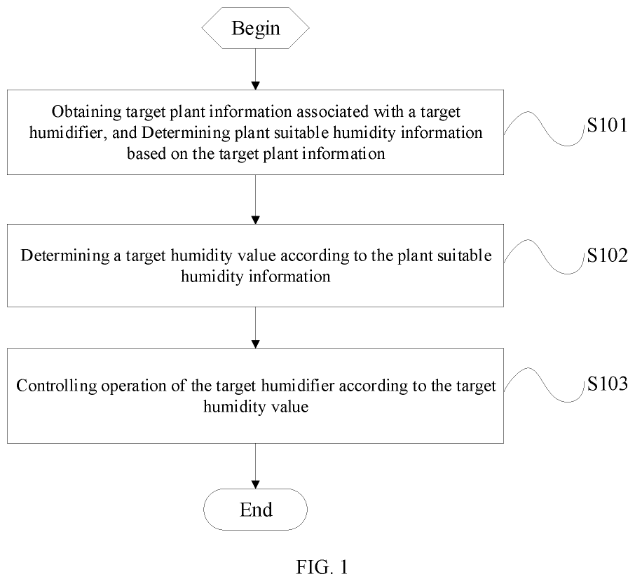

FIG. 1 is a flowchart of an exemplary humidity control method according to some embodiments of the present disclosure. As shown in FIG. 1, the humidity control method may be applied to an electronic device such as a mobile phone and a tablet computer, or to a central control device in an Internet of Things (IOT) system. As shown in FIG. 1, the humidity control method includes the following processes.

At step S101: target plant information associated with a target humidifier is obtained, and plant suitable humidity information is determined based on the target plant information.

The plant suitable humidity information includes a plurality of humidity values suitable for plant growth or a humidity range suitable for plant growth.

The plant suitable humidity information corresponding to different plants can be calculated and stored in a database in advance. When determining the plant suitable humidity information based on the target plant information, corresponding humidity information required for plant growth can be found from the database based on the target plant information, as the plant suitable humidity information.

In some embodiments, plant information at least includes a plant name. When storing the plant information of different plants in the database, in addition to storing plant names of different plants, the database also stores plant pictures, plant classifications, breeding difficulty, watering requirements, watering techniques, fertilization requirements, liquid fertilizer types, reproduction season, reproduction method, frequency of repotting, light requirements, air humidity requirements, desired humidity range, survival humidity range, desired temperature range, minimum temperature, cold tolerance zone, soil type, soil PH value, toxicity, lifespan, flowering season, flower color, leaf color, fruit color, common insect pests, common diseases, etc. The information may be displayed to the user as detailed plant information associated with plant names to satisfy user needs.

In some embodiments, a humidifier will establish an association with plant information of a specific plant. The plant information of the specific plant and the humidifier are placed in a same information set, and the plant information of the specific plant is used as humidity control reference information of the humidifier.

In some embodiments, the specific plant and the humidifier that need to be associated can be located in a same spatial range. For example, the specific plant is located in the same room as the humidifier, or the specific plant is within a coverage of the humidifier. The plant information can be used as the humidity control reference information to subsequently control the humidifier.

In some embodiments, before obtaining the target plant information associated with the target humidifier, the method further includes: obtaining room information associated with the plant change information; and determining a humidifier associated with the room information as the target humidifier.

The plant change information may be newly added plant information or deleted plant information. Alternatively, the plant change information may be all plant information included in the plant information collection after the plant information is added, deleted, or modified.

The above processes correspond to application scenarios of adding a new plant or removing a plant in a room.

During the above process, depending on a situation of adding a new plant or removing a plant in the room, the plant information of the newly added plant can be added and saved to an application program, i.e., APP or the plant information of the removed plant can be deleted from the APP to update the plant information.

When the plants in the room change, the humidity needs of the plants need to be satisfied after the change.

After the plant information is changed, the room information associated with the plant change information is obtained.

The room information corresponds to the humidifier information. The plant information, the humidifier information, and the room information are associated. When the plant information in a room changes, a target humidifier is determined based on the association. Based on the plant suitable humidity information, the humidifier in the same room is controlled to humidify the room. Thus, when the plant information changes, the humidifier in the same room with the plant corresponding to the plant change information can be accurately determined and room humidity can be accurately controlled.

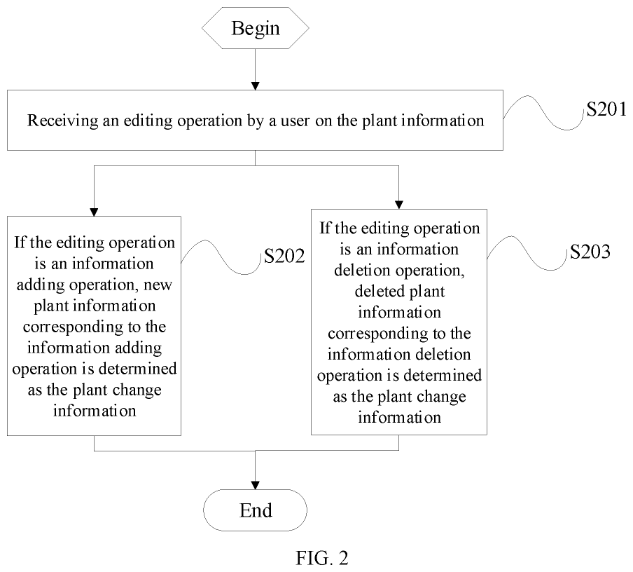

FIG. 2 is a flowchart of determining plant change information according to some embodiments of the present disclosure. As shown in FIG. 2, before obtaining the room information associated with the plant change information, the humidity control method further includes the following processes.

At step S201, an editing operation by a user on the plant information is received.

At step S202, if the editing operation is an information adding operation, new plant information corresponding to the information adding operation is determined as the plant change information.

Alternatively, after receiving the editing operation by the user on the plant information, the humidity control method further includes the following process.

At step S203, if the editing operation is an information deletion operation, deleted plant information corresponding to the information deletion operation is determined as the plant change information.

In some embodiments, the editing operation by the user on the plant information may include a text editing operation, an image uploading operation, controlling a humidity control device to perform content identification and extraction operations on uploaded images, an image content annotation operation, and establishing relationships between different plant information and humidifiers.

In some embodiments, the information adding operation may include: using a photo recognition function in the terminal to identify a plant from a plant photo, and adding the plant information corresponding to the identified plant to the APP. In some other embodiments, the information adding operation may include: user manually performing text editing and adding the plant information to the APP. The plant information may be synchronized and saved to a cloud server.

Correspondingly, when the plant information associated with the room information is added or deleted, the plant suitable humidity information matching the plant information will be obtained based on the plant change information, to effectively control the humidifier in subsequent humidity control processes. In response to plant increase and decrease, the corresponding humidifier is automatically controlled to adjust the room humidity timely and effectively. Thus, operating efficiency and operating automation are improved.

Returning to FIG. 1, at step S102, a target humidity value is determined according to the plant suitable humidity information. In this step, it is necessary to calculate the target humidity value based on the plant suitable humidity information to effectively control the humidifier subsequently.

In some embodiments, after the target humidity value is determined, the user may be provided with an opportunity to manually modify the target humidity value. That is, the user may choose to accept the target humidity value or adjust the target humidity value. Thus, the user has control flexibility, thereby improving the user experience.

For example, when determining the target humidity value based on the plant suitable humidity information, the number of plants indicated by the target plant information can be obtained, and based on the number of plants, the target humidity value can be determined using a corresponding humidity value calculation method.

In some embodiments, when determining the target humidity value, an average humidity value may be calculated.

In some embodiments, determining the target humidity value based on the plant suitable humidity information includes: obtaining the number of plants indicated by the target plant information; if the number of plants is one, determining a first plant suitable humidity range based on the plant suitable humidity information; and calculating an average value of a maximum humidity value and a minimum humidity value in the first plant suitable humidity range to obtain the target humidity value.

The above process corresponds to the case where the number of plants is one. In this case, the corresponding humidity value is calculated as follows. When the number of plants is one, it is necessary to determine a plant suitable humidity range based on the plant suitable humidity information. The plant suitable humidity range includes the maximum humidity value and the minimum humidity value. The average value of the two is directly calculated to obtain the target humidity value, that is, (maximum humidity value+minimum humidity value)÷2.

In some embodiments, determining the target humidity value based on the plant suitable humidity information includes: obtaining the number of plants indicated by the target plant information; if there are multiple plants, determining a second plant suitable humidity range for each plant according to the plant suitable humidity information; based on the maximum humidity value and the minimum humidity value in the second plant suitable humidity range, calculating an average humidity value to obtain the target humidity value.

The above process corresponds to the case where the number of plants is multiple. In this case, the corresponding humidity value is calculated as follows. When there are multiple plants (e.g., three plants), a plant suitable humidity range 1 is obtained for plant 1, a plant suitable humidity range 2 is obtained for plant 2, and a plant suitable humidity range 3 is obtained for plant 3. The plant suitable humidity range 1 includes a maximum humidity value 1 and a minimum humidity value 1. The plant suitable humidity range 2 includes a maximum humidity value 2 and a minimum humidity value 2. The plant suitable humidity range 3 includes a maximum humidity value 3 and a minimum humidity value 3.

When calculating the average humidity value to obtain the target humidity value based on the maximum humidity values and the minimum humidity values in the plant suitable humidity ranges, the maximum humidity value and the minimum humidity value in each plant suitable humidity range is averaged to obtain the average humidity value for each plant. Then, the average humidity values for all plants are averaged to obtain the target humidity value.

Specifically, it can be calculated as follows: {(maximum humidity value 1+minimum humidity value 1)÷2+(maximum humidity value 2+minimum humidity value 2)÷2+(maximum humidity value 3+minimum humidity value 3)÷2}÷3.

For example, the database contains 500 pieces of plant-related data information. Assuming that there is a corresponding humidifier in the room, and the user adds three plants to the room. Plant 1 has a plant suitable humidity range (50-75%), plant 2 has a plant suitable humidity range (40-60%), and plant 3 has a plant suitable humidity range (60-70%). Based on the maximum values and minimum values of the plant suitable humidity ranges corresponding to the three plants, the target humidity value is calculated to be approximately 60% according to the above method.

In some embodiments, before calculating the average humidity value based on the maximum humidity value and the minimum humidity value in the plant suitable humidity range to obtain the target humidity value, the humidity control method further includes: determining whether there is any overlap among the plant suitable humidity ranges; if it is determined that the overlap exists, performing the process of calculating the average humidity value based on the maximum humidity values and the minimum humidity values in the plant suitable humidity ranges to obtain the target humidity value; if it is determined that no overlap exists, outputting humidity setting prompt information. The humidity setting prompt information is used to prompt the user to manually input and control the humidity value.

When calculating the target humidity value based on multiple plant suitable humidity ranges, it is necessary to first determine whether any overlap exists among the multiple plant suitable humidity ranges. For example, plant 1 has a plant suitable humidity range (5-20%), plant 2 has a plant suitable humidity range (10-15%), and plant 3 has a plant suitable humidity range (10-20%). The overlap among plants 1, 2, and 3 is (10-15%).

If the overlap exists, the target humidity value may be calculated. If the overlap includes only a single value, the single value is directly used as the target humidity value. If no overlap exists, the user will be prompted to manually set the humidity value.

In this process, when there are multiple plants in the room, each plant may have a different plant suitable humidity range. Including the overlap among the plant suitable humidity ranges for all the plants in the automatic calculation of the target humidity value makes the calculated target humidity value more accurately satisfy the humidity needs of all the plants in the room, thereby ensuring effectiveness of the humidity control.

Returning to FIG. 1, at step S103, operation of the target humidifier is controlled according to the target humidity value.

After the target humidity value is calculated, the operation of the target humidifier can be controlled based on the target humidity value.

When controlling the operation of the target humidifier, the target humidifier can be controlled to use the target humidity value as the humidity target to adjust the room humidity.

In some embodiments, when controlling the operation of the target humidifier according to the target humidity value, the humidity control method includes: based on the target humidity value, outputting a humidity control instruction to the target humidifier. The humidity control instruction is used to instruct the target humidifier to stop humidification when an external humidity (i.e., outdoor humidity or humidity outside the room) exceeds the target humidity value by at least a first set threshold. The humidity control instruction is used to instruct the target humidifier to turn on humidification when the external humidity falls below the target humidity value by at least a second set threshold.

During this process, when the humidifier receives the humidity control instruction, the target humidity value is set to the target value, and the target humidity adjustment range of the humidifier is adjusted. For example, the humidifier is set to an adjustment range of 5% above and below the target humidity value for controlling the humidification. When the external humidity falls below the target humidity value by at least the 5% adjustment range, the humidifier is turned on. When the external humidity exceeds the target humidity by at least the 5% adjustment range, the humidifier is turned off. Thus, the room humidity is effectively controlled while energy is saved and environment is protected.

In the embodiments of the present disclosure, based on the relationship between the humidifier and the plant information, after obtaining the target plant information, the corresponding plant suitable humidity information is determined. The target humidity value for the humidity control is calculated. Based on the target humidity value, the humidifier is automatically controlled to adjust the room humidity as required by the plants. Thus, repeated manual adjustments of the target humidity value are avoided, and humidity control operation is streamlined with accuracy, efficiency, and energy saving.

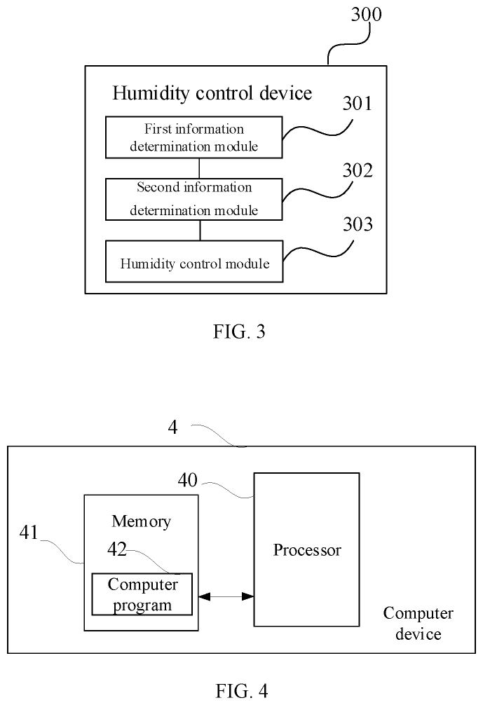

FIG. 3 is a schematic structural diagram of an exemplary humidity control device according to some embodiments of the present disclosure. Only related components of the humidity control device are shown for illustration purpose.

As shown in FIG. 3, the humidity control device 300 includes: a first information determination module 301, a second information determination module 302, and a humidity control module 303. The first information determination module 301 is used to obtain target plant information associated with a target humidifier, and determine plant suitable humidity information based on the target plant information. The second information determination module 302 is used to determine target humidity value according to the plant suitable humidity information. The humidity control module 303 is used to control the operation of the target humidifier according to the target humidity value.

In some embodiments, the second information determination module 302 is used to: obtain the number of plants indicated by the target plant information; if the number of plants is one, determine a first plant suitable humidity range based on the plant suitable humidity information; and calculate an average value of the maximum humidity value and the minimum humidity value in the first plant suitable humidity range to obtain the target humidity value.

In some embodiments, the second information determination module 302 is used to: obtain the number of plants indicated by the target plant information; if there are multiple plants, determine a second plant suitable humidity range for each plant according to the plant suitable humidity information; and calculate an average humidity value based on the maximum humidity value and the minimum humidity value in the second plant suitable humidity range to obtain the target humidity value.

In some embodiments, the second information determination module 302 is used to: determine whether any overlap exists among the second plant suitable humidity ranges for each plant; if it is determined that the overlap exists, calculate the average humidity value based on the maximum humidity value and the minimum humidity value in the second plant suitable humidity ranges to obtain the target humidity value; and if no overlap exists, output a humidity setting prompt information.

In some embodiments, the humidity control module 303 is used to: based on the target humidity value, output a humidity control instruction to the target humidifier. The humidity control instruction is used to instruct the target humidifier to stop humidification when an external humidity (i.e., outdoor humidity or humidity outside the room) exceeds the target humidity value by at least a first set threshold. The humidity control instruction is used to instruct the target humidifier to turn on humidification when the external humidity falls below the target humidity value by at least a second set threshold.

In some embodiments, the first information determination module 301 is used to: obtain room information associated with plant change information. A humidifier associated with the room information is determined as the target humidifier.

In some embodiments, the first information determination module 301 is used to: receive user editing operation on the plant information; if the editing operation is an information adding operation, determine newly added plant information corresponding to the information adding operation as the plant change information; or, if the editing operation is an information deletion operation, determine deleted plant information corresponding to the information deletion operation as the plant change information.

The humidity control device provided by the embodiment of the present disclosure can perform the humidity control method of the present disclosure, and can achieve the same technical effect. To avoid duplication, the detail description is omitted herein.

FIG. 4 is a schematic structural diagram of an exemplary computer device according to some embodiments of the present disclosure. As shown in FIG. 4, the computer device 4 includes: at least one processor 40 (only one is shown in FIG. 4), and a memory 41 storing a computer program 42 executable by the at least one processor 40. When being executed by the at least one processor 40, the computer program 42 causes the at least one processor 40 to perform the humidity control method of the present disclosure.

The computer device 4 may be a desktop computer, a notebook, a handheld computer, a cloud server, and other computing devices. The computer device 4 may include, but is not limited to, a processor 40 and a memory 41. Those skilled in the art should understand that FIG. 4 is merely an exemplary computer device 4 and does not constitute a limitation on the computer device 4. The computer device 4 may include more or less components than shown in FIG. 4. Some components may be combined. Different components may be used. For example, the computer device 4 may also include input and output devices, network access devices, buses, etc.

The processor 40 may be a central processing unit (CPU), other general-purpose processor, a digital signal processor (DSP), an application specific integrated circuit (ASIC), a field-programmable gate array (FPGA), other programmable logic devices, discrete gates or transistor logic devices, discrete hardware components, etc. A general-purpose processor may be a microprocessor or the processor may be any conventional processor, etc.

The memory 41 may be an internal storage unit of the computer device 4, such as a hard disk or memory of the computer device 4. The memory 41 may also be an external storage device of the computer device 4, such as a plug-in hard disk, a smart memory card (SMC), or a secure digital (SD) card, a flash card, etc. Further, the memory 41 may also include both an internal storage unit of the computer device 4 and an external storage device. The memory 41 is used to store the computer program and other programs and data required by the computer device 4. The memory 41 can also be used to temporarily store data that has been output or is to be output.

Those skilled in the art can clearly understand that for the convenience and simplicity of description, the division of the above functional units and modules is only used as an example. In actual applications, the above functions can be allocated to different functional units and modules according to actual needs. That is, dividing the internal structure of the device into different functional units or modules to complete all or part of the functions described above. Each functional unit and module in the embodiments can be integrated into one processing unit, or each unit can exist physically alone, or two or more units can be integrated into one unit. The integrated unit can be hardware-based or can also be implemented in the form of software functional units. In addition, the specific names of each functional unit and module are only for the convenience of distinguishing each other and are not used to limit the scope of protection of the present disclosure. For the specific working processes of the units and modules in the above system, reference can be made to the corresponding processes in the foregoing method embodiments, and the detail description thereof is omitted herein.

In the above embodiments, each embodiment is described with its own emphasis. For parts that are not detailed or documented in a certain embodiment, reference can be made to the relevant descriptions of other embodiments.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Those skilled in the art may implement the described functionality using different methods for each specific application, but such implementations should not be considered beyond the scope of the present disclosure.

In the embodiments of the present disclosure, it should be understood that the disclosed apparatus/computer device and methods can be implemented in other ways. For example, the apparatus/computer device embodiments described above are merely illustrative. For example, the division of modules or units is only a logical function division. In actual implementation, there may be other division methods, such as multiple units. Or components can be combined or can be integrated into another system, or some features can be omitted, or not implemented. On the other hand, the coupling or direct coupling or communication connection between each other shown or discussed may be through some interfaces, indirect coupling, or communication connection of devices or units, which may be in electrical, mechanical, or other forms.

The units described as separate components may or may not be physically separated, and the components shown as units may or may not be physical units, that is, they may be located in one place, or they may be distributed to multiple network units. Some or all of the units can be selected according to actual needs to achieve the purpose of the solution of the embodiments.

In addition, each functional unit in each embodiment of the present disclosure can be integrated into one processing unit, each unit can exist physically alone, or two or more units can be integrated into one unit. The above integrated units can be implemented in the form of hardware or software functional units.

If the integrated module/unit is implemented in the form of a software functional unit and sold or used as an independent product, it can be stored in a computer-readable storage medium. Based on this understanding, the present disclosure can implement all or part of the processes in the methods of the above embodiments, which can also be completed by instructing relevant hardware through a computer program. The computer program can be stored in a computer-readable storage medium, and when the program is executed by the processor, the steps of each of the above method embodiments can be implemented. The computer program includes computer program codes, which may be in the form of source code, object code, executable file or some intermediate form. The computer-readable medium may include: any entity or device capable of carrying the computer program code, recording media, a U disk, a portable hard disk, a magnetic disk, an optical disk, a computer memory, a read-only memory (ROM), a random-access memory (RAM), electrical carrier signals, telecommunications signals, and software distribution media, etc. It should be noted that the content contained in the computer-readable medium can be appropriately added or deleted according to the requirements of legislation and patent practice in the jurisdiction. For example, in some jurisdictions, according to legislation and patent practice, the computer-readable medium excludes electrical carrier signals and telecommunications signals.

This application implements all or part of the processes in the methods of the above embodiments, and can also be implemented through a computer program product. When the computer program product is run on a computer device, the computer device can implement the steps in each of the above method embodiments.

The above-described embodiments are only used to illustrate the technical solutions of the present disclosure, but not to limit them. Although the present disclosure has been described in detail with reference to the foregoing embodiments, those of ordinary skill in the art should understand that they can still implement the above-described implementations. The technical solutions described in the examples can be modified, or some of the technical features are equivalently replaced. These modifications or substitutions do not cause the essence of the corresponding technical solutions to deviate from the spirit and scope of the technical solutions in the embodiments of the present disclosure, and should be included in within the protection scope of the present disclosure.

What is claimed is:

1. A humidity control method, comprising:
obtaining target plant information associated with a target humidifier, and determining plant suitable humidity information based on the target plant information;
based on the plant suitable humidity information, determining a target humidity value; and
based on the target humidity value, controlling operation of the target humidifier.

2. The humidity control method according to claim 1, wherein:
the target plant information at least includes a plant name; and
determining the plant suitable humidity information based on the target plant information includes searching a database to determine the plant suitable humidity information based on the plant name.

3. The humidity control method according to claim 1, wherein determining the target humidity value based on the plant suitable humidity information comprising:
obtaining the number of plants indicated by the target plant information;
in response to the number of plants being one, determining a first plant suitable humidity range based on the plant suitable humidity information; and
calculating an average value of a maximum humidity value and a minimum humidity value in the first plant suitable humidity range to obtain the target humidity value.

4. The humidity control method according to claim 1, wherein determining the target humidity value based on the plant suitable humidity information comprising:
obtaining the number of plants indicated by the target plant information;
in response to the number of plants being multiple, determining a second plant suitable humidity range for each plant based on the plant suitable humidity information; and
calculating an average value of a maximum humidity value and a minimum humidity value in each second plant suitable humidity range, and calculating an average humidity value for all plants to obtain the target humidity value.

5. The humidity control method according to claim 4, wherein calculating the average humidity value for all plants to obtain the target humidity value comprising:
calculating an average humidity value for each plant;
adding the average humidity value for each plant to obtain a sum of the average humidity values for all plants; and
dividing the sum of the average humidity values for all plants by the number of plants to obtain the target humidity value.

6. The humidity control method according to claim 4, before calculating the average value of the maximum humidity value and the minimum humidity value in each second plant suitable humidity range, and calculating the average humidity value for all plants to obtain the target humidity value, the method further comprising:
determining whether any overlap exists among multiple second plant suitable humidity ranges for all the plants;
in response to the overlap existing, calculating the average value of the maximum humidity value and the minimum humidity value in each second plant suitable humidity range, and calculating the average humidity value for all plants to obtain the target humidity value; and
in response to no overlap existing, outputting humidity setting prompt information.

7. The humidity control method according to claim 6, further comprising:
in response to only a single value existing in the overlap, determining the single value to be the target humidity value.

8. The humidity control method according to claim 1, wherein controlling the operation of the target humidifier based on the target humidity value further comprises:
based on the target humidity value, outputting a humidity control instruction to the target humidifier, wherein the humidity control instruction is used to instruct the target humidifier to stop humidification when an external humidity exceeds the target humidity value by at least a first set threshold, and the humidity control instruction is used to instruct the target humidifier to turn on humidification when the external humidity falls below the target humidity value by at least a second set threshold.

9. The humidity control method according to claim 1, before obtaining the target plant information associated with the target humidifier, the method further comprising:
obtaining room information associated with plant change information; and
determining a humidifier associated with the room information as the target humidifier.

10. The humidity control method according to claim 9, before obtaining the room information associated with the plant change information, the method further comprising:
receiving an editing operation by a user on plant information;
in response to the editing operation being an information adding operation, determining newly added plant information corresponding to the information adding operation as the plant change information;
in response to the editing operation being an image recognition or smart phone recognition operation, determining newly recognized plant information corresponding to the image recognition or smart phone recognition operation as the plant change information; and
in response to the editing operation being an information deletion operation, determining deleted plant information corresponding to the information deletion operation as the plant change information.

11. A humidity control device, comprising a memory storing a computer program and a processor, wherein when being executed by the processor, the computer program causes the processor to:
obtain target plant information associated with a target humidifier, and determine plant suitable humidity information based on the target plant information;
based on the plant suitable humidity information, determine a target humidity value; and
based on the target humidity value, control operation of the target humidifier.

12. The humidity control device according to claim 11, wherein:
the target plant information at least includes a plant name; and
when determining the plant suitable humidity information based on the target plant information, the processor is further configured to search a database to determine the plant suitable humidity information based on the plant name.

13. The humidity control device according to claim 11, wherein when determining the target humidity value based on the plant suitable humidity information, the processor is further configured to:
obtain the number of plants indicated by the target plant information;
in response to the number of plants being one, determine a first plant suitable humidity range based on the plant suitable humidity information; and
calculate an average value of a maximum humidity value and a minimum humidity value in the first plant suitable humidity range to obtain the target humidity value.

14. The humidity control device according to claim 11, wherein when determining the target humidity value based on the plant suitable humidity information, the processor is further configured to:
obtain the number of plants indicated by the target plant information;
in response to the number of plants being multiple, determine a second plant suitable humidity range for each plant based on the plant suitable humidity information; and
calculate an average value of a maximum humidity value and a minimum humidity value in each second plant suitable humidity range, and calculate an average humidity value for all plants to obtain the target humidity value.

15. The humidity control device according to claim 14, wherein when calculating the average humidity value for all plants to obtain the target humidity value, the processor is further configured to:
calculate an average humidity value for each plant;
add the average humidity value for each plant to obtain a sum of the average humidity values for all plants; and
divide the sum of the average humidity values for all plants by the number of plants to obtain the target humidity value.

16. The humidity control device according to claim 14, wherein before calculating the average value of the maximum humidity value and the minimum humidity value in each second plant suitable humidity range, and calculating the average humidity value for all plants to obtain the target humidity value, the processor is further configured to:
determine whether any overlap exists among multiple second plant suitable humidity ranges for all the plants;
in response to the overlap existing, calculate the average value of the maximum humidity value and the minimum humidity value in each second plant suitable humidity range, and calculate the average humidity value for all plants to obtain the target humidity value; and
in response to no overlap existing, output humidity setting prompt information.

17. The humidity control device according to claim 16, wherein the processor is further configured to:
in response to only a single value existing in the overlap, determine the single value to be the target humidity value.

18. The humidity control device according to claim 11, wherein when controlling the operation of the target humidifier based on the target humidity value, the processor is further configured to:
based on the target humidity value, output a humidity control instruction to the target humidifier, wherein the humidity control instruction is used to instruct the target humidifier to stop humidification when an external humidity exceeds the target humidity value by at least a first set threshold, and the humidity control instruction is used to instruct the target humidifier to turn on humidification when the external humidity falls below the target humidity value by at least a second set threshold.

19. The humidity control device according to claim 11, wherein before obtaining the target plant information associated with the target humidifier, the processor is further configured to:
obtain room information associated with plant change information; and
determine a humidifier associated with the room information as the target humidifier.

20. A computer-readable storage medium storing a computer program, when being executed by a processor, the computer program causing the processor to:
obtain target plant information associated with a target humidifier, and determine plant suitable humidity information based on the target plant information;
based on the plant suitable humidity information, determine a target humidity value; and
based on the target humidity value, control operation of the target humidifier.
